(19) United States
(12) Patent Application Publication
(10) Pub. No.: US 2005/0091277 A1
(43) Pub. Date: Apr. 28, 2005

(54) Method and system for protecting individuals and property

(76) Inventor: Robert A. Desman, Marietta, GA (US)

Correspondence Address: Mitchell B. Wasson;HOFFMAN, WASSON & GITLER, P.C., Suite 522, 2461 South Clark Street, Arlington, VA, 22202, US

(21) Appl. No.: 10/944,701

(22) Filed: Sep. 21, 2004

Related U.S. Application Data
(60) Provisional application No. 60/505,651, filed on Sep. 25, 2003.

(51) Int. Cl. G06F 17/00

(52) U.S. Cl. 707/104.1

(57) ABSTRACT

A system and method of protecting individuals or property from a potential risk. A centralized, secure database is established for receipt of photographs and additional information taken by a subscriber of another individual, or scene. This information would be inputted into the subscriber's file. In the event of a criminal incident, the proper legal authority would have access to the subscriber's file. This would allow information included in the subscriber's file to be used in the investigative process related to that criminal incident.

### CROSS REFERENCE TO RELATED APPLICATIONS

The present application claims the benefit of provisional patent application Ser. No. 60/505,651, filed on Sep. 25, 2003.

### FIELD OF THE INVENTION

The present invention is directed to the field of protecting individuals as well as property from a potential risk.

### BACKGROUND OF THE INVENTION

Early in 2003, the National Association of Realtors conducted a web-survey of its 561,991 members regarding personal safety issues. A total of 4,337 members responded representing a 95% confidence level and a standard error of +/−3.11. Also included in the survey were several questions for real estate association executives. The sample was 71% female with 55% between the ages 35 and 55 years. The majority (71%) were sales agents with another 10% being broker/agents; 65% were principally involved in residential sales and another 28% in residential/commercial sales with over 50% of their business deriving from the residential sector. The two most populous experiential segments were agents with 6-15 years of experience (34%) and 1-5 years of experience (32%).

Twenty-five percent of the respondents had been victims in incidents that ranged from violent crime to simple harassment; 71% reported that they would rely on the internet to find safety resources. Fifty-one percent look for safety information on their own, 42% depend on their broker to provide such information, and 39% look to their local associations as a source of information. Over half the association executives receive safety inquiries and 86% of their associations provide safety information or resources. Nevertheless, 82% of association websites provide no information, 38% of their executives receive no incident reports, and 53% of the associations have no procedure for collecting information or reporting incidents.

According to the Bureau of Justice Statistics (BJS) 2001 data, compiled from local police reports, males are 50% more likely to be the victims of a crime of violence or assault, perpetrated by a casual acquaintance or stranger, than are women. This data are highly skewed, however, by the high incidence of occurrences within the young (12-24 years old), non-white, male population. Over 11% of the unmarried population at large is at high risk (113.6 incidents per 10,000 population) along with 7% of those whose family income exceeds $35,000 per year. Divorced or separated individuals comprise over one-third of the incidents in the unmarried category. After the age of 35, one is more likely to be the victim of a violent crime than an assault. Both males and females are more likely to be victims of simple versus aggravated assault. Extrapolating from the data, divorced or separated individuals, over the age of 35 with incomes in excess of $35,000 per year are considerably more likely to be a victim of a violent crime than the population in general, and both males and females are equally likely to be victimized.

In 2001, one of every forty people over the age of 12 were victims of a violent crime; 85% were assault victims, 11% were robbery victims, and 4% were raped or sexually assaulted. Of the 4.8+ million assaulted persons, 25.12% were victims of aggravated assault with over 75% of them being threatened with a weapon. With the exception of robbery, where the assailant has a 3 to 1 likelihood of being a total stranger, the majority of all other perpetrators are individuals with whom the victim was acquainted.

Although published crime statistics do not identify victims, or perpetrators, by profession, it may be inferred that real estate agents posses a considerably higher risk profile than does the general population. Initially, the typical agent conforms very closely to the high risk category in the population at large: over age 35, divorced or separated, earning in excess of $35,000 per year. Beyond this, several factors associated with the profession itself contribute to their “at risk” status.

As commission sales people, agents seek to establish rapport with their clientele. They express interest, caring, and concern and tolerate a broader range of potential client behavior than they might of others. They are eager to accommodate and quick to create feelings of closeness. In doing so, they attempt to elevate clients' feelings of power and control, confidence, and mutuality. If done well, the client becomes more frank, trusting, loyal, and decisive at critical decision points. Unlike other purchase decisions, home buying/selling is often dominated by numerous emotional issues. Agents recognize this and attempt to cater to both the emotional as well as the economic dimension of the experience.

Additionally, agents subscribe to a doctrine of “success breeds success.” Consequently, they seek to project an image of success. They drive late model, often luxury, automobiles, are well-tailored, and often wear expensive clothing and jewelry. Together, the appearance of sensitivity, accommodation, and prosperity makes them attractive targets for predatory behavior.

Contributing to agent risk exposure are the agents' customer focus and the nature of the industry context. Agents see individuals as prospective clients or sales facilitators, not as potential assailants. As a result they tend to ignore safe practices when dealing with other agents (or those portending to be agents), vendors, maintenance and repair workers, and potential buyers and sellers. Their domain is dominated by vacant properties and isolated locations. They generally work alone in open-house showings and odd-hour appointments with total strangers. Experienced agents often find themselves at greater risk by convincing themselves that their experience has endowed them with an ability to “sense” dangerous situations. Finally, agents feel that actions implying concern for their personal safety might place them at a competitive disadvantage. If they take steps to improve the security of their work environment, clients may be alienated and move on to an agent who appears less “paranoid.” Agents who demonstrate the least regard for their personal safety, in essence, set the tone for safe practices within the industry.

The National Association of Realtors has recognized the industry's safety problems and has endeavored to raise the safety consciousness of its membership. It has made safe practice training materials and resources available and advertised extensively on its home and affiliate websites. To this end one week a year has been designated as Realtor Safety Week.

### SUMMARY OF THE INVENTION

The problems previously discussed are addressed by the following generalized description of the present invention.

The vast majority of occupationally-related crimes against real estate professionals likely derive from their interaction with strangers and casual acquaintances in isolated locations. It can be inferred, therefore, that perpetrator anonymity is a profound contributor to incident occurrence.

Other industries have taken the offense against such incidents by mounting security cameras and apprising potential perpetrators of their presence. No readily available data report on the impact of such practices, but the investment in these systems and insurance company willingness to reduce premiums where such systems are in place suggest that depriving perpetrators of anonymity is an effective crime deterrent. Although such practices are both tenable and cost-effective in fixed locations, technical limitations precluded their practical adoption in non-fixed settings.

With the advent of the photo cellular telephone, the security camera concept can now be extended to the mobile work force. By photographing individuals, with their knowledge, (or in some cases without their knowledge) in a secure environment, and sending the photograph to a non-accessible archive, mobile-workers considerably reduce the probability that a criminal incident will follow. In addition to creating a time-date-stamped record of a meeting, the practice also places the pictured individual at a specific location. For the real estate agent, and their listing clientele the practice has a twofold advantage: 1) a potential perpetrator is dissuaded from taking action against the agent because there is, with the potential perpetrator's knowledge, an irretrievable record of their meeting, and 2) in the event the individual is examining the property with criminal intention, there is a record of him/her at the scene.

Once the photograph is taken, it is sent to a secure server by the wireless e-mail feature on the client's cellular telephone, or by other means, such as a hardwired connection. Here it is time-date stamped and filed in the client's individual file. Filed photographs cannot be accessed by external means and are only made available to public safety officials who are in the process of investigating a crime. To ensure document security, the server is maintained at an undisclosed location and mirrored at another location in another region of the country. At such time as it is made aware of industry-related incident, the system, according to the present invention, will also broadcast alerts to its clients using the text feature of the clients' telephones.

Because there is little manifest precedence for the practice of taking security photographs in such a manner, some initial resistance might be expected. There are, however, several points that may alleviate legitimate concerns.

Initially, individuals need to be assured that the photograph is taken for security purposes only, and that it will not be accessible to anyone, including the agent, with the exception of public safety personnel in the course of their official duties.

Secondly, whether aware or not, most individuals are already photographed on the average of five times each day in retail stores, gas stations, office buildings, banks, airports, commuter stations, at intersections, ATM machines, ticket offices, and on freeways. This fact can then be relayed to reluctant individuals.

Thirdly, visible endorsement of the practice by government, law enforcement, and industry associations and high profile members will accelerate acceptance.

Finally, agents need to encourage and support each other in the adoption of the practice. As individuals, they have a right to engage in high-risk practices, but as professionals they have a responsibility to their peers to not place them or their clients' property at risk.

The present invention contemplates the establishment of a website allowing potential customers to subscribe to the service, receive safety information and safety alerts, and where customers can review their account status and receive statistical reports about their data transmission activity. Other services may be added as they come available or are deemed necessary.

Invitations have been received to address the 50+ Georgia NAR chapters and the 100 plus nationwide industry journals and newsletters will be approached to provide briefings on the provided services. Peer-to-peer sales presentations will be scheduled for major real estate brokerages. Further, plans are in progress to provide an informational flyer in the company mailboxes of over 9,000 local agents and brokers. The greater Atlanta area has been selected as a test market and service launch site.

The present invention cannot claim that the practices enumerated here will absolutely ensure the safety of its clients, their possessions, or the property of their clientele, nor can it take responsibility for data quality or transmission or any activity that takes place in front of the secured server gateway. At such time as a photograph enters the gateway, all reasonable and industry accepted precautions to preserve the security and integrity of the data delivered will be taken. The service concept mirrors practices generally accepted and employed in fixed-location commercial settings and is anticipated to provide the same level of protection as is experienced in those locations. The present invention will provide copies of requested files to legitimate law enforcement agencies involved in the investigation of a criminal activity or incident and when ordered to do so by a court of law.

### BRIEF DESCRIPTION OF THE DRAWINGS

The present invention will be better understood and objects other than those set forth above will become apparent when consideration is given to the following detailed description thereof. Such description makes reference to the annexed drawings wherein:

FIG. 1 is a block diagram of the system of the present invention; and

FIG. 2 is a flow diagram of the method of the present invention.

### DETAILED DESCRIPTION OF THE INVENTION

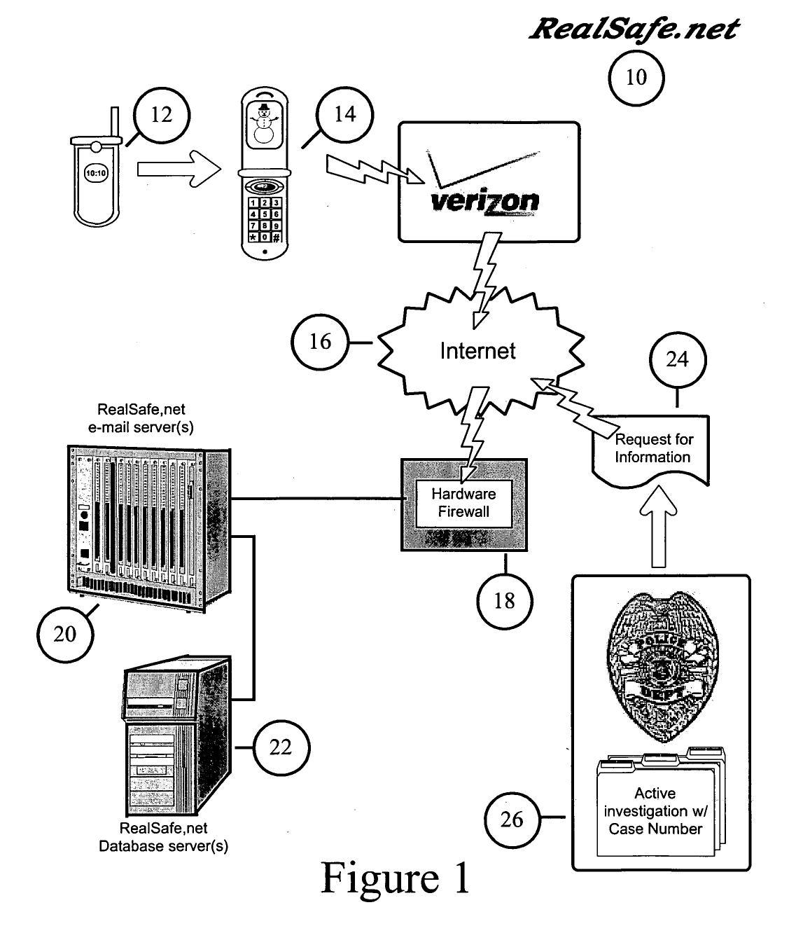

As illustrated in FIG. 1, the present invention 10 employs a camera-enabled cellular telephone (camera phone) 12 to take a photograph of a particular individual. Although the present invention will be described with respect to its use in the real estate industry, it is noted that the service can be used by anyone; particularly those whose occupation and/or lifestyle places them in contact with casual acquaintances or strangers in remote or isolated locations. Once the photograph 14 is taken, it is transmitted utilizing the attributes of a particular telephone carrier. As illustrated in FIG. 1, Verizon is utilized as the carrier. However, it is important to note that: a) any wireless phone carrier or e-mail service provider would have the facility to function in the present invention, and b) any device capable of taking and transmitting a photograph may be used in lieu of a camera phone. The photograph, which is in the form of an e-mail attachment, is transmitted over the internet 16 to a secure, remote location. A hardware firewall 18 is utilized to ensure the security of the system. The e-mail is then passed through to one or more e-mail and database servers 20, 22.

If it has come to the attention of one or more law enforcement agencies that a crime, such as, but not limited to a burglary or assault has been committed against a person or property subscribing to the invention, that law enforcement agency 26 would contact 24 the system administrator to request a copy of the subscriber's data file or a specific document (e.g. photograph) therein. Although FIG. 1 illustrates an e-mail request, any means mutually deemed agreeable may be used to make a request for such information (e.g. post, telephone, personal contact, etc.).

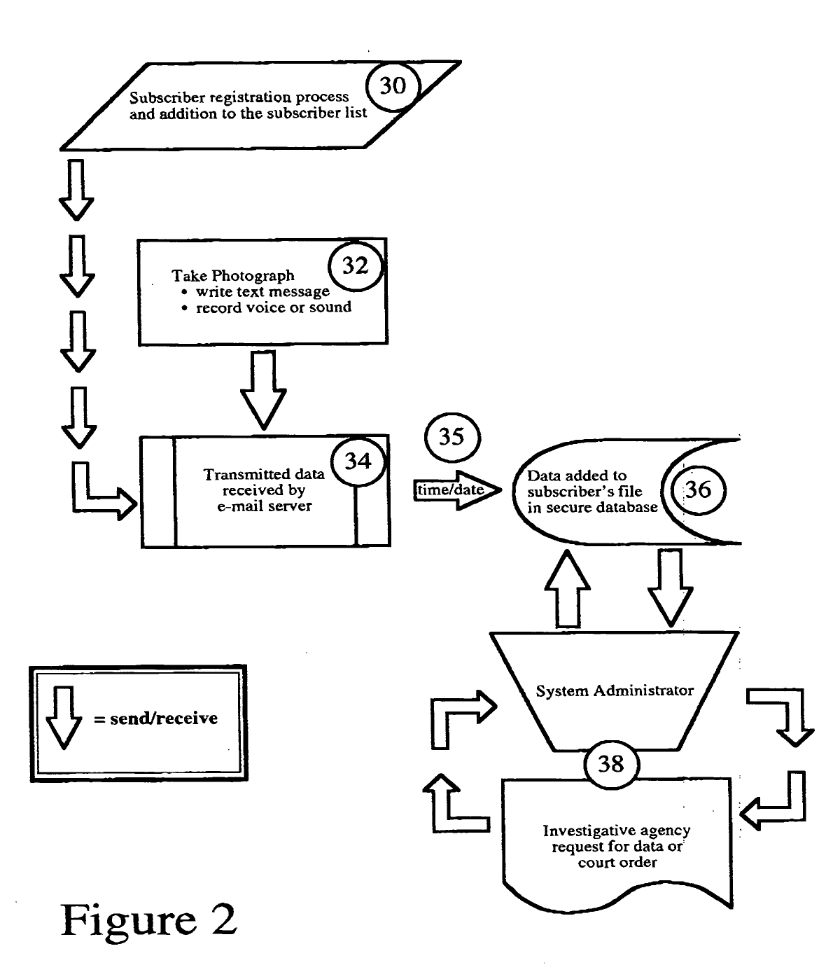

FIG. 2 illustrates, generally, the manner in which the present system would operate. A subscriber, such as a real estate agent, would register with the system at step 30. Upon registration, each subscriber would then have a file created and maintained for the receipt and retention of his or her e-mail documents and their attachments (text messages, photographs, and voice recordings). Once the photograph is taken at step 32, it would be transmitted as an e-mail over the internet to the e-mail server at step 34. At this point, the e-mail, along with any attachments will be time and date stamped at step 35, forwarded to the database server at step 36, and added to the subscriber's file. If it is determined that a criminal activity has occurred, the proper law enforcement agency would contact the systems administrator 38 to request the photograph as well as any additional information appended to that photograph.

Although, as indicated hereinabove, any type camera phone may be utilized in the system and method of the present invention, the invention will now be described specifically with use of the Verizon Wireless LG 6000 camera phone. The process of taking an individual's photograph would begin by opening the “flip-top” on the phone and then pressing the center button on the phone to take the photograph. At this point, the subscriber would select option number 1 “Take Pix” and point the camera lens at the person to be photographed. The subscriber would then push the “OK” button to take the picture and then, once again, push the “OK” button to start the send process.

The subscriber has the option of choosing the address to which the photograph will be sent. In this instance, the user would utilize pics@secure.realsafe.net as the e-mail address. The address can be pre-programmed into the phone or can be manually inputted into the phone each time an e-mail with an attached photograph is sent. At this point, the subscriber would push the “send” button to transmit the photograph as an e-mail with attachment using the facility provided by Verizon Wireless. The transmitted document will first be routed over the cellular grid to the Verizon Wireless e-mail server where it will be relayed to the “realsafe.net” e-mail server located in an undisclosed location for security purposes. It is also noted that redundant servers running in two separate locations, each with redundant power and internet access, can be employed by the system according to the present invention.

Along with the photograph, the subscriber has the option of sending additional material to be included in the subscriber's file. For example, the subscriber can utilize a text message like any standard e-mail. This text message could include additional material associated with the individual being photographed, such as the subject's name, the make, and model and license number of the subject's automobile, as well as the subject's telephone number and address. Additionally, or in lieu of or in addition to the text message, the e-mailed photograph could include voice or other types of sound material. This material could include the same content provided in the text message.

Upon reaching the secure location, the server would review the sender's or subscriber's identifying information included in the e-mail. This information includes, but is not limited to, the sender's cell phone number included in the e-mail return address. This identifying information is checked against a subscriber list. If the information received by the server is from a non-subscriber, the incoming e-mail is sent to a “dead letter file” and the sender is sent an e-mail explaining how to subscribe to the service. If the sender is a subscriber, the e-mail and attachment(s) (photo, text, sound) is date and time stamped and forwarded to the subscriber's personal file in the database server.

There is no limit to the number of e-mails and photographs that can be sent to a personal file. A single e-mail may contain all pertinent information or a body of information can be sent in a series of e-mails. Since all incoming documents are filed in chronological sequence, a total information package can be assembled by selecting documents forward and backward from any place in the file. This feature enables subscribers to capture and send information before, during, and after a meeting. In the real estate agent example provided above, the agent may choose to send an e-mail immediately before meeting a buyer containing the address of the meeting location and any additional information as deemed significant (e.g. the name and phone number of the buyer). Upon meeting the buyer, a following e-mail with a photo may be sent. Following such a practice may reduce the intrusiveness of the security procedure. Since documents are stored sequentially by date and time, associating multi-part records is easily accomplished.

As new features and technologies emerge in the wireless telephony industry, user “friendliness” and transmission speed will be impacted. As subscribers become more comfortable with their instruments, alternative procedures for documenting meetings may be devised.

Subscriber files are stored in a secure database at undisclosed locations. All industry-standard computer security precautions are built into the system and back-up files are archived off the primary server. Access to the database and associated files is limited to authorized personnel. This practice serves two purposes: 1) the documented individual's privacy is protected since the subscriber cannot use the file for any other than its intended purpose, and 2) without access, the subscriber cannot be compelled to erase or modify a document once it is transmitted. This feature protects the subscriber as the meeting is irretrievably and unalterably documented.

In the event of a criminal incident, a subscriber's file will be made available to public safety officials in the course of a legitimate investigation. To gain access to a subscriber's file contents, a formal request, including a case number, is submitted to RealSafe.net by the investigating agency. In all but extremely time-sensitive situations the request will be in written form accompanied by the appropriate documentation. At the discretion of RealSafe.net management, critical information may be shared with investigative personnel, given there is an active case number, when the sharing of such information is time-critical (when the subscriber is in imminent danger or when such practices will facilitate subscriber safety). Consistent with the 4^{th} amendment of the United States Constitution, at no time will any agency have access to the database—requested information must relate to a specific subscriber and his/her personal file(s). The only foreseeable exception to the practices outlined above is when the system administrator is presented with an official court order to surrender specific information. All legitimate information requests and demands will be accommodated by providing the investigator with an exact copy of the subscriber file(s) as it exists in the database and/or archives.

While the present invention has been illustrated and described in terms of particular apparatus and methods of use, it is apparent that equivalent components may be substituted for those shown and other changes can be made within the scope of the present invention. For example, although the present invention has been described with respect to wirelessly transmitting a photograph taken with a camera phone to a secure location, it is noted that a photograph can be transmitted to the secure location by other means. For example, a digital photograph can be taken of a subject using a camera or camera-enabled PDA, and sent via the internet to the secure location using a computer or other wired connection. Additionally, a security camera could be provided at a remote location, such as an open house. This camera could operate through the use of a motion sensor. Any and all photographs and motion pictures would be sent to the secure server by wired or wireless transmission and placed in the subscriber's file.

1. A method of protecting a first individual or property from potential criminal activity, including the steps of:
taking a photograph of a second individual or property;
transmitting said photograph to a secure database provided at a location remote from the individual or personal property; and
allowing access of said photograph from said secure database by an authorized entity, in the event of the occurrence of the criminal activity.

2. The method in accordance with claim 1, further including the step of wirelessly transmitting said photograph to the internet and then to said secure database.

3. The method in accordance with claim 1, further including the steps of initially establishing a file for the first individual and entering said photograph in said file.

4. The method in accordance with claim 1, wherein said first individual is a real estate or leasing agent.

5. The method in accordance with claim 1, further including a text message appended to said photograph.

6. The method in accordance with claim 1, further including a sound message appended to said photograph.

7. The method in accordance with claim 5, further including a sound message appended to said photograph.

8. A system for protecting a first individual or property from potential criminal activity comprising:
a camera producing a photograph of a second individual or property;
a private, secure database, provided with a plurality of individual data;
a means utilizing the internet for transmitting said photograph to one of said individual data files in said private secure database; and
a secure means whereby a law enforcement or public safety agency may gain access to the contents of one of said individual data files, held in said secure database, in the event of the occurrence of a criminal activity.

9. The system in accordance with claim 8, wherein said photograph is wirelessly transmitted to the internet and then to said private, secure database.

10. The system in accordance with claim 8, wherein said photograph is transmitted to said internet and then to said private, secure database by a wired connection.

11. The system in accordance with claim 8, wherein said private, secure database is provided with a plurality of subscriber files into which appropriate photographs are entered.
